(19) United States
(12) Patent Application Publication
(10) Pub. No.: US 2003/0237017 A1
(43) Pub. Date: Dec. 25, 2003

(54) Component fault isolation in a storage area network

(76) Inventor: Mahmoud Khaled Jibbe, Wichita, KS (US)

Correspondence Address: LSI Logic Corporation, Corporate Legal Department, Intellectual Property Services Group, 1551 McCarthy Boulevard, M/S D-106, Milpitas, CA, 95035, US

(21) Appl. No.: 10/178,696

(22) Filed: Jun. 24, 2002

(51) Int. Cl. G06F 11/30

(52) U.S. Cl. 714/4

(57) ABSTRACT

A mechanism is provided for isolating faults in a complex configuration by capturing a snapshot of the configuration and comparing the snapshot with a certified configuration. These configurations are stored in a database. The comparison is carried out on a component-by-component basis. The specifications of these components are checked against the specifications stored in the database that outline the details of the certified configurations. The mechanism of this invention encompasses a mechanism for capturing the snapshot and the specifications of the component versions and settings, as well as a mechanism for comparing the customer's configuration against the certified configurations.

### BACKGROUND OF THE INVENTION

1. Technical Field

The present invention relates to storage area networks and, in particular, to fault isolation in a storage area network. Still more particularly, the present invention provides a method and apparatus for validating configurations and components in a storage area network and for isolating faults.

2. Description of the Related Art

A network of storage disks is referred to as a storage area network (SAN). In large enterprises, a SAN connects multiple servers to a centralized pool of disk storage. Compared to managing hundreds of servers, each with their own disks, SANs improve system administration. By treating all of the storage as a single resource, disk maintenance and routine backups are easier to schedule and control. The SAN network allows data transfers between computers and disks at the same high peripheral channel speeds as when they are directly attached. SANs can be centralized or distributed. A centralized SAN connects multiple servers to a collection of disks, whereas a distributed SAN typically uses one or more switches to connect nodes within buildings or campuses.

Due to the complexity of configuration and administration of SANs, a high likelihood for errors exists. Most problems commonly detected at a customer site or in a lab environment are related to the usage and construction of unsupported configurations or uncertified components in a released product. This problem is typically caused by trial and error adopted by common users, recommendations by a sales representative, or during a system upgrade. Uncertified components can cause a complete SAN system to be inoperative due to the incompatibility of the components.

Problems can be detected by going to a customer site or a lab and manually checking the configuration and components. This method of validating configurations and components may be time consuming and may have a high margin of failure, even if the debugger is an experienced person. As such, the true source of a problem may take an excessive amount of time to locate or may remain undiscovered, resulting in increased cost or damaged customer confidence.

Therefore, it would be advantageous to provide an improved method and apparatus for validating configurations and components in a storage area network and to isolate faults.

### SUMMARY OF THE INVENTION

The present invention provides a mechanism for isolating faulty components in a complex configuration by capturing a snapshot of the configuration and comparing the snapshot with a certified configuration. These configurations are stored in a database. The comparison is carried out on a component-by-component basis. The specifications of these components are checked against the specifications stored in the database that outline the details of the certified configurations. The mechanism of this invention encompasses a mechanism for capturing the snapshot and the specifications of the component versions and settings, as well as a mechanism for comparing the customer's configuration against the certified configurations.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram illustrating an example storage area network in accordance with a preferred embodiment of the present invention;

FIG. 2 is a block diagram illustrating a scan of topologies in a storage area network in accordance with a preferred embodiment of the present invention;

FIG. 3 is an example configuration snapshot in accordance with a preferred embodiment of the present invention;

FIGS. 4A and 4B are example screenshots of settings and versions dialogs in accordance with a preferred embodiment of the present invention;

FIG. 5 is a flowchart illustrating the operation of a component scan process in accordance with a preferred embodiment of the present invention; and

FIG. 6 is a flowchart illustrating the operation of a resolving a storage area network problem issue in accordance with a preferred embodiment of the present invention.

### DETAILED DESCRIPTION

The description of the preferred embodiment of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention and the practical application to enable others of ordinary skill in the art to understand the invention for various embodiments with various modifications as are suited to the particular use contemplated.

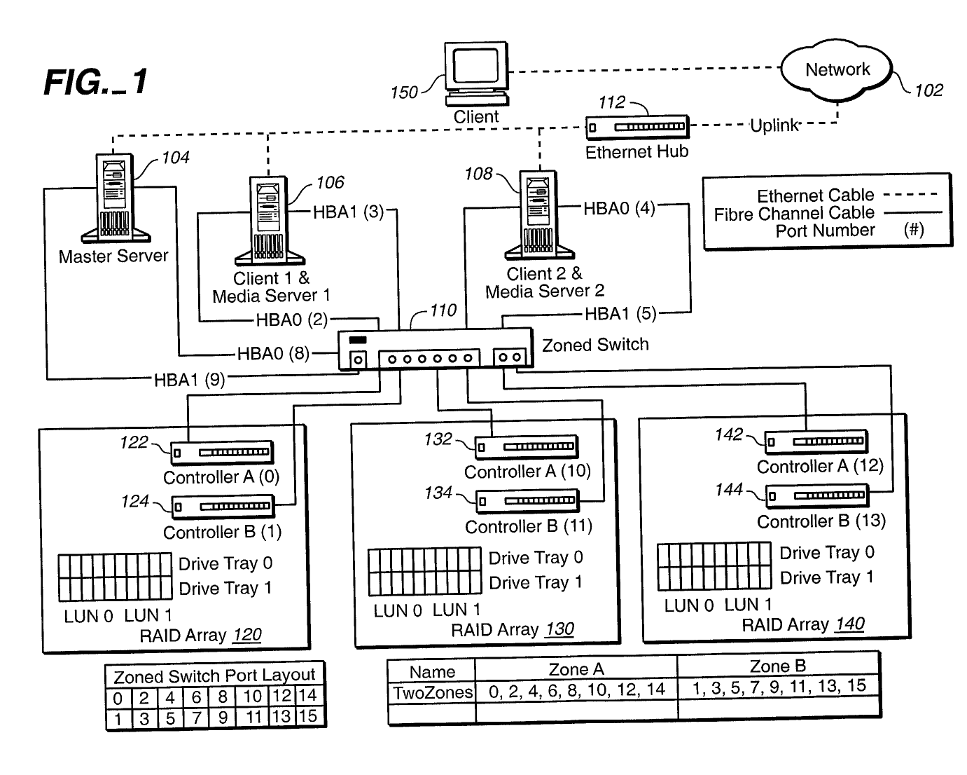

With reference now to the figures and in particular with reference to FIG. 1, a block diagram is shown illustrating an example storage area network in accordance with a preferred embodiment of the present invention. Master server 104 connects to client 1 and media server 1 106 and client 2 and media server 2 108 via Ethernet cable. Master server 104 connects to port 8 of zoned switch 110 using host bus adapter 0 (HBA0) via fibre channel cable. The master server also connects to port 9 of the zoned switch using host bus adapter 1 (HBA1). Similarly, client 1 106 connects to port 2 of the zoned switch using HBA0 and port 3 using HBA1. Client 2 108 connects to port 4 of the zoned switch using HBA0 and port 5 using HBA1.

The SAN also includes redundant array of inexpensive disks (RAID) arrays 120, 130, 140. In the example shown in FIG. 1, RAID array 120 includes controller A 122 and controller B 124. Controller A 122 connects to port 0 of zoned switch 110 via fibre channel cable and controller B 124 connects to port 1. RAID array 130 includes controller A 132 and controller B 134. Controller A 132 connects to port 10 of the zoned switch and controller B 134 connects to port 11. Similarly, RAID array 140 includes controller A 142 and controller B 144. Controller A 142 connects to port 12 of switch 110 and controller B 144 connects to port 13.

As depicted in FIG. 1, switch 110 is a zoned switch with zone A and zone B. Zone A includes ports 0, 2, 4, 6, 8, 10, 12, and 14 and zone B includes ports 1, 3, 5, 7, 9, 11, 13, and 15. Logical unit number (LUN) 0 and LUN 1 from RAID array 120 are mapped to master server 104. LUN 0 and LUN 1 from RAID array 130 are mapped to media server 1 106. And LUN 0 and LUN1 from RAID array 140 are mapped to media server 2 108.

The architecture shown in FIG. 1 is meant to illustrate an example of a SAN environment and is not meant to imply architectural limitations. Those of ordinary skill in the art will appreciate that the configuration may vary depending on the implementation. For example, more or fewer RAID arrays may be included. Also, more or fewer media servers may be used. The configuration of zones and ports may also change depending upon the desired configuration. In fact, switch 110 may be replaced with a switch that is not zoned.

Master server 104, media server 1 106, and media server 2 108 connect to Ethernet hub 112 via Ethernet cable. The Ethernet hub provides an uplink to network 102. In accordance with a preferred embodiment of the present invention, client 150 connects to network 102 to access components in the SAN. Given the Internet protocol (IP) addresses of the components in the SAN, client 150 may scan the components for specifications and configuration information, such as settings, driver versions, and firmware versions. The client may then compare this information against a database of certified configurations. Any components or configurations that do not conform to the certified configurations may be isolated as possible sources of fault. A user at client 150 may then change the settings, driver versions, and firmware versions of the components and rescan the SAN to determine whether the configuration is a certified configuration.

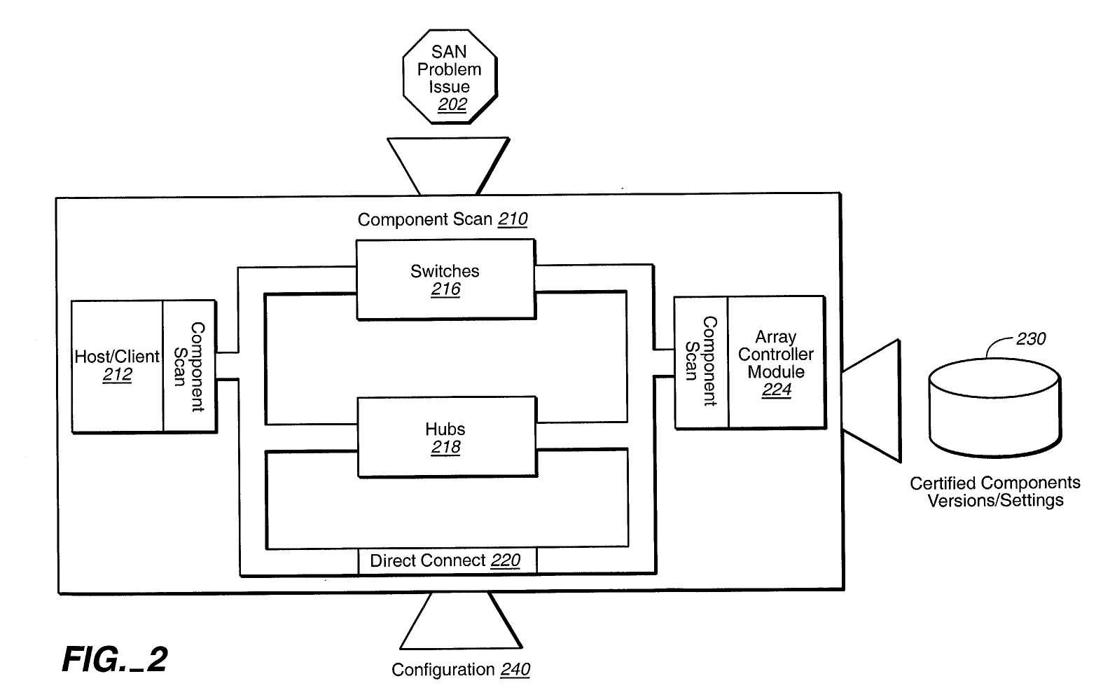

Turning now to FIG. 2, a block diagram illustrating a scan of topologies in a storage area network is shown in accordance with a preferred embodiment of the present invention. SAN problem issue 202 is received and a component scan 210 is performed. Component scan 210 extracts information about components, including host/client devices 212, switches 216, hubs 218, direct connections 220, and array controller modules 224. Component scan 210 then compares the extracted information against certified components, versions, and settings in database 230 and outputs configuration 240 including highlighted differences between the scanned configuration and the certified configuration.

The scan mechanism of the present invention extracts information about the components via different methods. These methods depend on the type of components. For example, for a host model, the scan mechanism parses the system file stored on the host/client memory to obtain the required information. When scanning a host adapter, the scan mechanism parses the registry file, driver file properties, and the configuration file. For a switch, the scan mechanism may telnet to the switch and issue a “switchShow” command to get the switch model, statistics, and Name server contents to determine the connectivity (port number, port type, and zone). The scan mechanism may also telnet to a hub and issue a “HUBShow” command to the hub management software to get the hub model, statistics, and port contents to determine connectivity (port number and zone). Furthermore, the scan mechanism may telnet to a RAID controller module and issue fibre channel shell commands (FcAll 5, FcAll 10, and FcAll 2) to get RAID firmware (FW), configuration, model, statistics, connectivity, and port type. For a tape device, the scan mechanism may parse the registry file, driver file properties, and the configuration file and, for a router, the scan mechanism may parse the driver file properties and the configuration file.

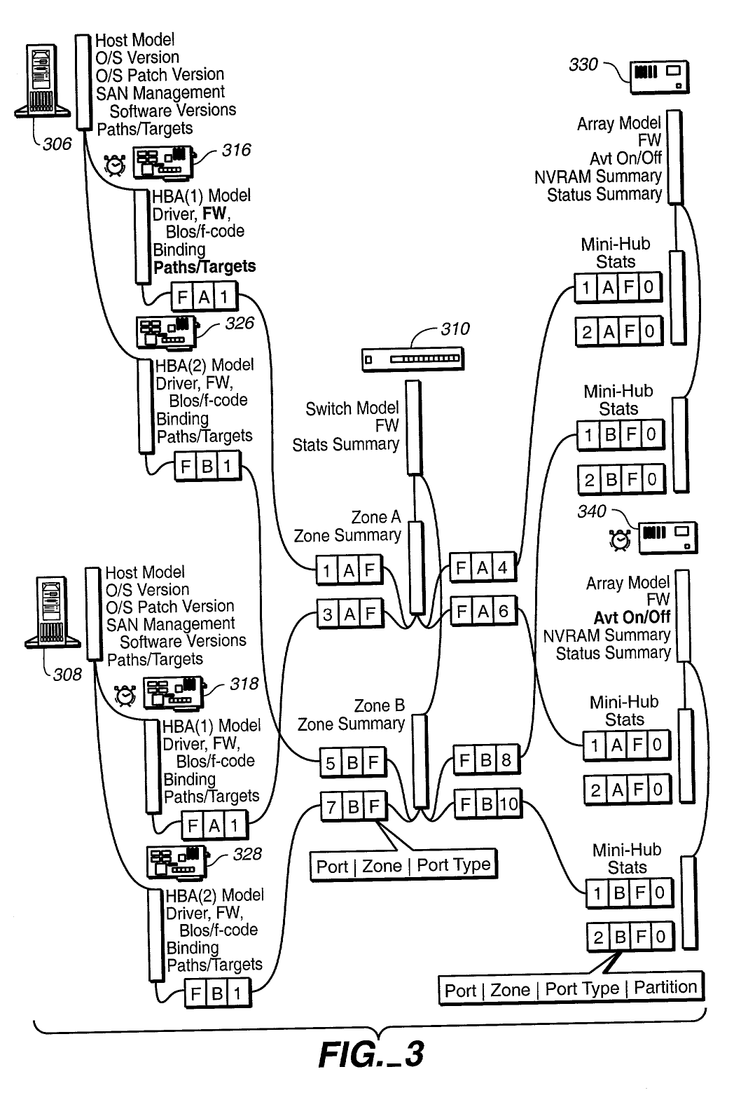

With reference now to FIG. 3, an example configuration snapshot is shown in accordance with a preferred embodiment of the present invention. The configuration snapshot illustrates the configurations, settings, and other extracted information for the components in the SAN. The configuration snapshot may be presented graphically using icons and the like in a product data graph. For example, graphical icons may be displayed to represent the components in the SAN. In addition, vertical or horizontal lines may depict various aspects of a components, such as the settings, versions, zones, etc. Lines may also be used to represent the connections between components. The configuration snapshot may also be presented in other manners, such as a textual representation or a table. Also, alternative graphical techniques for representing the configuration of a SAN in a product data graph may be used, other than those shown in FIG. 3.

For media server 306, the configuration snapshot includes, for example, the host model, the operating system version, operating system patch version, SAN management software versions, and paths and targets. Also, for media server 306, host bus adapter 316 and host bus adapter 326 are shown. Similarly, for media server 308, the extracted information for the server and for host bus adapter 318 and hot bus adapter 328 are shown.

For each host bus adapter, the host bus adapter model, driver, firmware, BIOS/f-code, binding, and paths and targets are shown. Further, the port type, zone and port are shown illustrating the connection to switch 310. For example, host bus adapter 316 has a fibre channel port connected to zone A of the switch and connected through port 1 of the adapter. As illustrated in FIG. 3, host bus adapter 316 is connected to port 1 of switch 310, host bus adapter 326 is connected to zone B and port 5, host bus adapter 318 is connected to zone A and port 3, and host bus adapter 328 is connected to zone B and port 7.

For each switch or hub, the configuration snapshot displays how each port is initialized. Each port must initialize as the correct zone and type to communicate with host bus adapter or array controller. For example, a port may initialize as a fabric type (F) or a fabric loop type (FL). For switch 310, the configuration snapshot includes, for example, the switch model, firmware, and statistics summary. The configuration snapshot for the switch also includes parameters for each zone. Each port of each zone may include port, zone, and port type.

For RAID array 330 and RAID array 340, the configuration snapshot includes, for example, the array model, firmware, automatic volume transfer (avt) on/off, non-volatile random-access memory (NVRAM) summary, and status summary. The configuration snapshot for each RAID array also includes mini-hub statistics for each controller. The mini-hub statistics may include port, zone, port type, and partition. The configuration snapshot may also illustrate the connections to switch 310.

Furthermore, the scan mechanism may highlight differences between the pre-captured certified snapshot and the current snapshot. For example, an alarm is displayed next to host bus adapter 316 and RAID array 340. An alarm may be displayed by highlighting a component, such as by displaying an icon in association with the component. Furthermore, the firmware and paths/targets settings are highlighted for host bus adapter 316 and the avt on/off setting is highlighted for array 340. A person debugging a SAN problem may simply check and modify the highlighted components, versions, and/or settings and rescan the configuration. This process may be repeated until a certified configuration results. In other words, a debugger may verify and correct the configuration until no differences are highlighted.

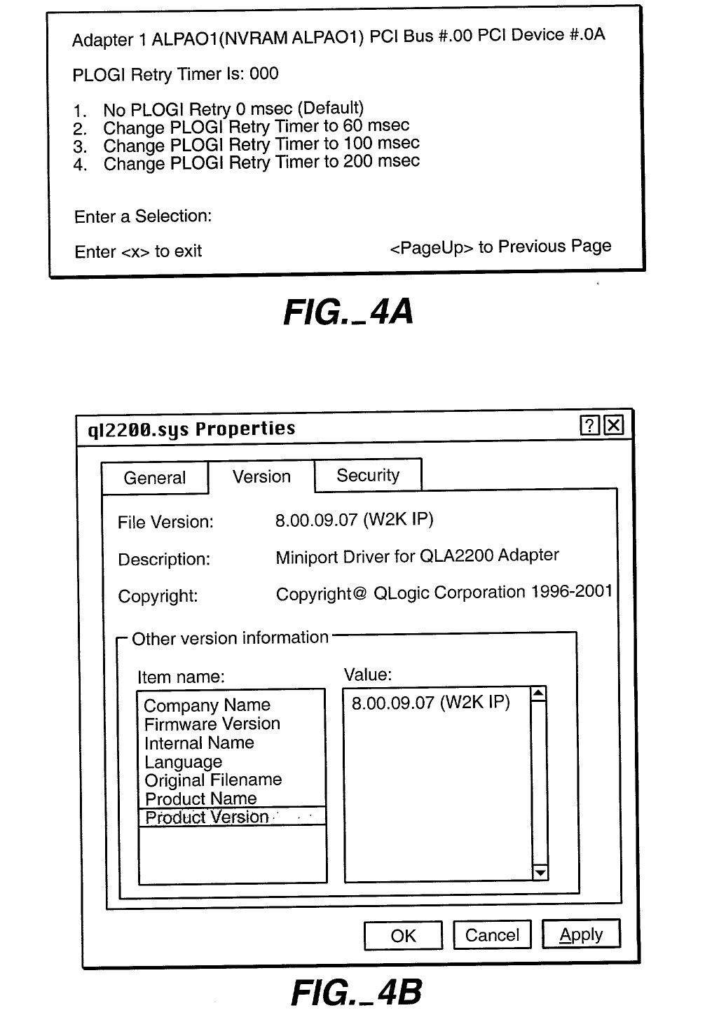

Turning now to FIGS. 4A and 4B, example screenshots of settings and versions dialogs are shown in accordance with a preferred embodiment of the present invention. More particularly, FIG. 4A illustrates an example dialog screen for changing settings for an adapter. FIG. 4B illustrates an example dialog screen for updating firmware and/or driver versions.

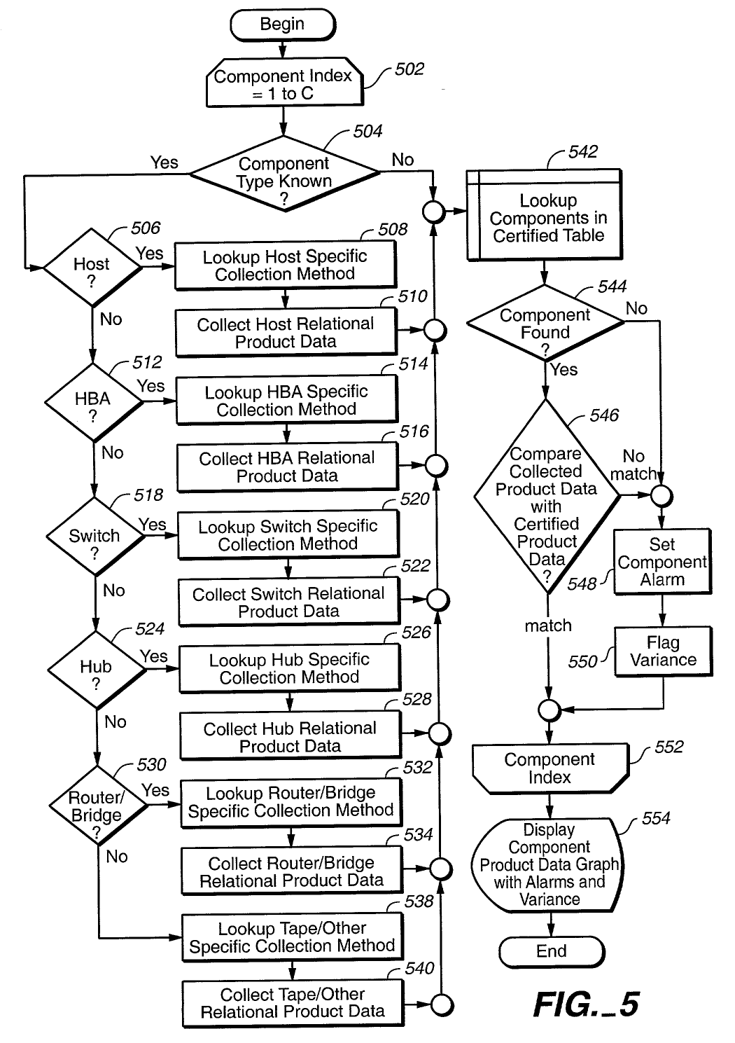

With reference to FIG. 5, a flowchart illustrating the operation of a component scan process is shown in accordance with a preferred embodiment of the present invention. The process begins and a loop begins with a component index being equal to a value from one to C, where C is the number of components recorded with a connectivity scan (step 502). A determination is made as to whether the component corresponding to the component index is a known type (step 504). If the component is a known type, a determination is made as to whether the component is a host (step 506). If the component is a host, the process looks up the host specific collection method (step 508) and collects the host relational product data (step 510). The host specific collection method may be, for example, Solaris, Windows, IRIX, etc. Thereafter, the process proceeds to step 542 to look up the component in the certified table.

If the component is not a host in step 506, a determination is made as to whether the component is a host bus adapter (step 512). If the component is a host bus adapter, the process looks up the HBA specific collection method (step 514) and collects the HBA relational product data (step 510). The HBA specific collection method may be, for example, Solaris/LSI, Windows/Qlogic, AIX/Emulix, etc. Thereafter, the process proceeds to step 542 to look up the component in the certified table.

If the component is not an HBA in step 512, a determination is made as to whether the component is a switch (step 518). If the component is a switch, the process looks up the switch specific collection method (step 520) and collects the switch relational product data (step 522). The switch specific collection method may be, for example, Ethernet/APIs, Serial/CLI, etc. Thereafter, the process proceeds to step 542 to look up the component in the certified table.

If the component is not a switch in step 518, a determination is made as to whether the component is a hub (step 524). If the component is a hub, the process looks up the hub specific collection method (step 526) and collects the hub relational product data (step 528). The hub specific collection method may be, for example, Ethernet/APIs, Serial/CLI, etc. Thereafter, the process proceeds to step 542 to look up the component in the certified table.

If the component is not a hub in step 524, a determination is made as to whether the component is a router or bridge (step 530). If the component is a router or bridge, the process looks up the router/bridge specific collection method (step 532) and collects the router/bridge relational product data (step 534). The router/bridge collection method may be, for example, Ethernet/APIs, Serial/CLI, etc. Thereafter, the process proceeds to step 542 to look up the component in the certified table.

If the component is not a router/bridge in step 530, a determination is made as to whether the component is a tape storage device or other known component (step 536). If the component is a tape storage device or other known component, the process looks up the tape/other specific collection method (step 538) and collects the tape/other relational product data (step 540). The tape/other specific collection method may be, for example, Ethernet/APIs, Serial/CLI, etc. Thereafter, the process proceeds to step 542 to look up the component in the certified table.

Returning to step 504, if the component is not a known type, the process proceeds directly to step 542 to look up the component in the certified table. Then, a determination is made as to whether the component is found in the certified database (step 544). If the component is found, the process compares the collected product data with the certified product data (step 546). If there is not a match in step 546 or the component is not found in step 544, the process sets a component alarm (step 548), flags the variance (step 550), and the loop repeats. Also, if there is match in step 546, the loop repeats. The loop exits when all the components are processed (step 552). When all components are processed, the process displays the component product data graph with alarms and variance (step 554) and ends.

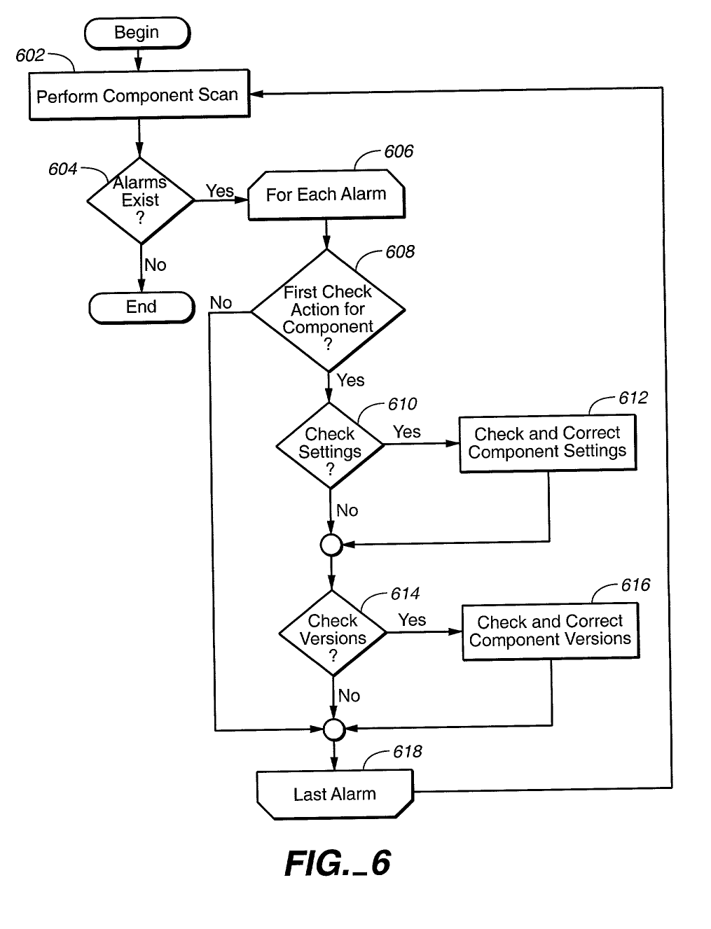

With reference now to FIG. 6, a flowchart illustrating the operation of a resolving a storage area network problem issue is shown in accordance with a preferred embodiment of the present invention. The process begins and a debugger performs a component scan (step 602). A determination is made as to whether alarms exist (step 604). If no alarms exist, the process ends.

However, if alarms exist in step 604, a loop begins, wherein the loop executes for each alarm (step 606). A determination is made as to whether this is a first check action for the component for which the alarm was set (step 608). If this is the first check action for the component, a determination is made as to whether to check the component settings (step 610). If the settings are to be checked, the debugger checks and corrects component settings (step 612) and a determination is made as to whether to check the component driver, software, or firmware versions (step 614). If the settings are not to be checked in step 610, the process proceeds to step 614 to determine whether to check the versions.

If the versions are to be checked in step 614, the debugger checks and corrects component driver, software, or firmware versions (step 616) and the loop repeats. Also, if the versions are not to be checked in step 614, the loop repeats. Returning to step 610, if this is not the first check action for the component, the problem is not likely to be solved by modifying settings or updating driver, software, or firmware versions and the loop repeats. The loop repeats until the last alarm is processed.

When the last alarm is processed, the process returns to step 602 to rescan the configuration. The debugger may repeatedly rescan and correct the configuration until either a certified configuration results or it is determined that the SAN problem issue cannot be resolved in this manner. For example, a component may have been replaced with or upgraded to an uncertified component that does not work properly in the configuration. The component scanning mechanism of the present invention will identify the uncertified component and the problem may be corrected remotely by modifying settings or updating driver or firmware versions. Occasionally, a problem may continue to be identified when the SAN is rescanned, even after modifying settings and/or updating driver or firmware versions. In these cases, the debugger may have to correct the problem on site.

The present invention solves the disadvantages of the prior art by providing a mechanism for documenting certified configurations. The present invention also automates the validation of a customer configuration against certified configurations. A customer support group may verify a customer validation without going on site. Furthermore, the mechanism of the present invention reduces the possibility of human error and optimizes the duration cycle for validating a customer configuration, thus reducing the expense in supporting customers.

It is important to note that while the present invention has been described in the context of a fully functioning data processing system, those of ordinary skill in the art will appreciate that the processes of the present invention are capable of being distributed in a form of a computer readable medium of instructions and in a variety of forms. Further, the present invention applies equally regardless of the particular type of signal bearing media actually used to carry out the distribution. Examples of computer readable media include recordable-type media such a floppy disc, a hard disk drive, a RAM, a CD-ROM, a DVD-ROM, and transmission-type media such as digital and analog communications links, wired or wireless communications links using transmission forms such as, for example, radio frequency and light wave transmissions. The computer readable media may take the form coded formats that are decoded for actual use in a particular data processing system.

What is claimed is:

1. A method for resolving problem issues in a storage area network, comprising:
performing a component scan to identify a plurality of components;
comparing each component in the plurality of components to a database of certified components;
associating a component alarm with each component that does not match a certified component in the database of certified components.

2. The method of claim 1, wherein the step of performing a component scan comprises:
identifying at least a first component;
determining a component type for the first component;
performing a collection method based on the component type to collect component product data for the first component.

3. The method of claim 2, wherein the component type comprises one of a host, a host bus adapter, a switch, a hub, a router, a bridge, and a tape storage device.

4. The method of claim 2, wherein the component product data comprises at least one of component model data, operating system data, storage area network management software data, path and target data, driver version data, firmware version data, binding data, port number, switch zone, port type, automatic volume transfer parameter, nonvolatile random access memory data, status data, and partition data.

5. The method of claim 2, wherein the step of comparing comprises determining whether the first component is found in the database of certified components.

6. The method of claim 2, wherein the step of comparing comprises comparing the component product data to certified product data in the database of certified components.

7. The method of claim 6, wherein the step of associating an alarm comprises flagging a variance between the component product data and the certified product data.

8. The method of claim 7, further comprising generating a component product data graph based on the results of the component scan.

9. The method of claim 8, wherein the component product data graph highlights the variance between the component product data and the certified product data.

10. The method of claim 1, further comprising generating a component product data graph based on the results of the component scan.

11. The method of claim 10, wherein the component product data graph includes at least one component alarm.

12. The method of claim 10, wherein the component product data graph comprises a graphical representation of a configuration of the storage area network.

13. The method of claim 1, further comprising resolving the component alarm.

14. The method of claim 13, further comprising performing a component scan to determine whether the component alarm is resolved.

15. The method of claim 14, wherein the step of resolving the component alarm comprises modifying at least one parameter of the first component.

16. The method of claim 14, wherein the step of resolving the component alarm comprises updating a driver or firmware version for the first component.

17. The method of claim 1, wherein the method is performed at a location that is remote from the storage area network.

18. An apparatus for resolving problem issues in a storage area network, comprising:
scanning means for performing a component scan to identify a plurality of components;
comparison means for comparing each component in the plurality of components to a database of certified components;
association means for associating a component alarm with each component that does not match a certified component in the database of certified components.

19. The apparatus of claim 18, wherein the scanning means comprises:
identification means for identifying at least a first component;
determination means for determining a component type for the first component;
collection means for performing a collection method based on the component type to collect component product data for the first component.

20. The apparatus of claim 19, wherein the component type comprises one of a host, a host bus adapter, a switch, a hub, a router, a bridge, and a tape storage device.

21. The apparatus of claim 19, wherein the component product data comprises at least one of component model data, operating system data, storage area network management software data, path and target data, driver version data, firmware version data, binding data, port number, switch zone, port type, automatic volume transfer parameter, nonvolatile random access memory data, status data, and partition data.

22. The apparatus of claim 19, wherein the comparison means comprises means for determining whether the first component is found in the database of certified components.

23. The apparatus of claim 19, wherein the comparison means comprises means for comparing the component product data to certified product data in the database of certified components.

24. The apparatus of claim 23, wherein the association means comprises means for flagging a variance between the component product data and the certified product data.

25. The apparatus of claim 24, further comprising means for generating a component product data graph based on the results of the component scan.

26. The apparatus of claim 25, wherein the component product data graph highlights the variance between the component product data and the certified product data.

27. The apparatus of claim 18, further comprising means for generating a component product data graph based on the results of the component scan.

28. The apparatus of claim 27, wherein the component product data graph includes at least one component alarm.

29. The apparatus of claim 27, wherein the component product data graph comprises a graphical representation of a configuration of the storage area network.

30. The apparatus of claim 18, further comprising resolution means for resolving the component alarm.

31. The apparatus of claim 30, further comprising rescanning means for performing a component scan to determine whether the component alarm is resolved.

32. The apparatus of claim 31, wherein the resolution means comprises means for modifying at least one parameter of the first component.

34. The apparatus of claim 31, wherein the resolution means comprises means for updating a driver or firmware version for the first component.

35. The apparatus of claim 18, wherein the apparatus is located remote from the storage area network.

36. A computer program product, in a computer readable medium, for resolving problem issues in a storage area network, comprising:
instructions for performing a component scan to identify a plurality of components;
instructions for comparing each component in the plurality of components to a database of certified components;
instructions for associating a component alarm with each component that does not match a certified component in the database of certified components.

37. The computer program product of claim 36, wherein the instructions for performing a component scan comprises:
instructions for identifying at least a first component;
instructions for determining a component type for the first component;
instructions for performing a collection method based on the component type to collect component product data for the first component.

38. The computer program product of claim 37, wherein the instructions for comparing comprises instructions for comparing the component product data to certified product data in the database of certified components.

39. The computer program product of claim 38, wherein the instructions for associating an alarm comprises instructions for flagging a variance between the component product data and the certified product data.

40. The computer program product of claim 36, further comprising instructions for generating a component product data graph based on the results of the component scan.

41. The computer program product of claim 36, further comprising instructions for resolving the component alarm.

42. The computer program product of claim 41 further comprising instructions for performing a component scan to determine whether the component alarm is resolved.
